(19) United States
(12) Patent Application Publication
(10) Pub. No.: US 2017/0203658 A1
(43) Pub. Date: Jul. 20, 2017

(54) CHARGING CONTROL SYSTEM FOR ELECTRIC VEHICLE

(71) Applicant: HYUNDAI MOTOR COMPANY, Seoul (KR)

(72) Inventors: Young Jin JANG, Pohang-si (KR); Hyung Souk KANG, Seoul (KR)

(21) Appl. No.: 15/350,868

(22) Filed: Nov. 14, 2016

(30) Foreign Application Priority Data
Jan. 18, 2016 (KR) 10-2016-0005970

(51) Int. Cl. B60L 11/18

(52) U.S. Cl. CPC B60L 11/1811; B60L 11/1868; B60L 11/1861

(57) ABSTRACT

A charging control system for an electric vehicle includes a main battery supplying power for driving the electric vehicle, an auxiliary battery supplying power to electric loads of the electric vehicle, a multi-converter connecting an external power supply, the main battery and the auxiliary battery and outputting voltage for charging the main battery and the auxiliary battery when a switch therein is turned on, and a controller controlling turning on/off the switch in the multi-converter in accordance with charged states of the main battery and the auxiliary battery so that the main battery or the auxiliary battery is charged.

### CROSS REFERENCE TO RELATED APPLICATION

The present application claims the benefit of priority to Korean Patent Application No. 10-2016-0005970, filed Jan. 18, 2016 with the Korean Intellectual Property Office, the entire contents of which is incorporated herein for all purposes by this reference.

### TECHNICAL FIELD

The present disclosure relates to a charging control system for an electric vehicle that can realize various charging plans among normal power, a main battery, and an auxiliary battery, using a multi-transformer having a plurality of turn ratios.

### BACKGROUND

Electric vehicles, including hybrid vehicles, may be equipped with two batteries, namely a main battery that supplies power to the vehicle and an auxiliary battery of the type that has been used in gasoline vehicles. In general, the main battery generates high voltage and the auxiliary battery generates low voltage.

In the battery system of environment-friendly vehicles of the related art, the main battery is controlled and managed by a BMS (Battery Management System) and the auxiliary battery is managed in the same manner as managed in gasoline vehicles. Further, the auxiliary battery of environment-friendly vehicles of the related art is charged by the main battery.

That is, in the battery system of electric vehicles of the related art, the main battery and the auxiliary battery are separately controlled, but the fuel efficiency is low. Further, the auxiliary battery is charged or discharged by a rapid increase of electric loads in the vehicles without consideration of the state of the auxiliary battery, whereby the auxiliary battery may be overcharged or over-discharged.

Accordingly, Korean Patent Application Publication No. 2014-0078174, titled “Charging controlling method for plug-in hybrid electric vehicle and electric vehicle” has made an attempt to solve these problems by proposing various methods for efficient charging by improving the operation of an automotive control system.

However, even in such methods, a main battery and an auxiliary battery are still separately controlled, which is not efficient in terms of control and management, and still entails the problem of low fuel efficiency.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to propose a charging control system for an electric vehicle that allows for integration of a slow charger and a low-voltage transformer using a multi-transformer having a plurality of turn ratios, which can therefore realize various charging control plans through even simple control.

In order to achieve the above object, according to one aspect of the present disclosure, there is provided a charging control system for an electric vehicle that includes: a main battery supplying power for driving an electric vehicle; an auxiliary battery supplying power to electric loads of the electric vehicle; a multi-converter connecting an external power supply, the main battery, and the auxiliary battery and outputting voltage for charging the main battery and the auxiliary battery when a switch therein is turned on; and a controller controlling turning on/off the switch in the multi-converter in accordance with charged states of the main battery and the auxiliary battery so that the main battery or the auxiliary battery is charged.

The system further includes a power factor corrector connected between the external power supply and the multi-converter and improving a power factor of external power.

The system further includes: a first converter connected between an output terminal for the main battery of the multi-converter and the main battery to achieve bidirectional conversion; and a second converter connected between an output terminal for the auxiliary battery of the multi-converter and the auxiliary battery to achieve bidirectional conversion.

The controller may control turning on/off converters for external power, the main battery, and the auxiliary battery in the multi-converter and may control turning on/off and control buck/boost modes of the first converter and the second converter in accordance with charged states of the main battery and the auxiliary battery.

When both the main battery and the auxiliary battery need to be charged, the controller may turn on the converters for the external power, the main battery, and the auxiliary battery in the multi-converter and may turn on the first converter and the second converter in the boost mode.

When the main battery needs to be charged, the controller may turn on the converters for the external power, the main battery, and the auxiliary battery in the multi-converter, may turn on the first converter in the boost mode, and may turn off the second converter.

When power is not supplied from the external power supply, the controller may turn off the converter for the external power in the multi-converter.

When the main battery is not fully discharged, the controller may turn on the first converter in the buck mode and the second converter in the boot mode.

When the main battery needs to be charged, the controller may turn on the first converter in the boost mode and the second converter in the buck mode.

The controller may determine the charged states of the main battery and the auxiliary battery on the basis of the SOC of the main battery and the auxiliary battery.

The multi-converter may include a multi-transformer converting voltage of the external power supply to voltage for charging the main battery and the auxiliary battery.

The coil winding factor of the multi-transformer satisfies the following expression,

N>M>K

where N is a coil winding factor at a primary side, M is a coil winding factor at the main battery, and K is a coil winding factor at the auxiliary battery.

The present disclosure can provide the following effects.

First, a slow charger and a low-voltage transformer can be integrated by a multi-transformer having a plurality of turn ratios, so the manufacturing costs are reduced and the circuit is simplified, and accordingly, the loss of power is decreased.

Second, it is possible to realize various charging plans according to the charged states of the main battery and the auxiliary battery by controlling only the operation mode and turning on/off converters.

Third, when it is difficult to charge the main battery, but the main battery is fully discharged, it is possible to temporarily charge the main battery using the auxiliary battery, so the emergency driving function of an electric vehicle is enhanced.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a diagram showing a configuration of a charging control system for an electric vehicle according to an embodiment of the present disclosure; and

FIG. 2 is a diagram showing a configuration of the charging control system for an electric vehicle according to an embodiment of the present disclosure.

### DETAILED DESCRIPTION

Hereinafter, embodiments of the present disclosure will be described in detail with reference to the accompanying drawings.

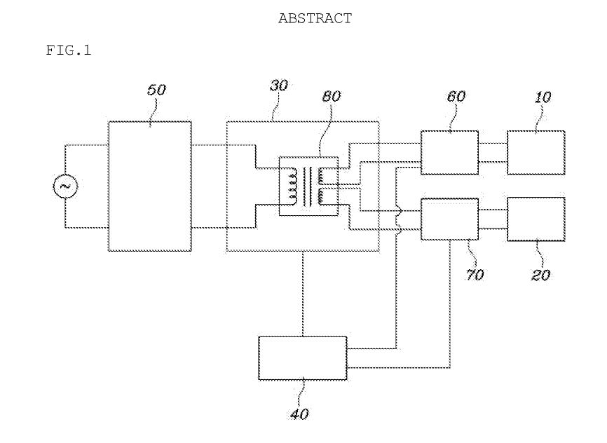

A charging control system for an electric vehicle according to an embodiment of the present disclosure, as shown in FIG. 1, may include: a main battery 10 supplying power for driving an electric vehicle; an auxiliary battery 20 supplying power to electric loads of an electric vehicle; a multi-converter 30 connecting an external power supply, the main battery 10, and the auxiliary battery 20 and outputting voltage for charging the main battery 10 and the auxiliary battery 20 when a switch therein is turned on; and a controller 40 controlling turning on/off the switch in the multi-converter 30 in accordance with the charged states of the main battery 10 and the auxiliary battery 20 so that the main battery 10 or the auxiliary battery 20 can be charged.

The multi-converter 30 is a device that may output voltages at several levels and is provided in various types. Among the various types of converters, the multi-converter 30 proposed in the present disclosure may use a multi-transformer 80 that converts the voltage of an external power supply into a voltage for charging the main battery 10 and the auxiliary battery 20. Further, the multi-converter 30 proposed in the present disclosure can output one voltage other than voltages at several levels. Thus, if necessary, the multi-converter 30 can be used as a common single-type converter.

The converter changes input voltage into output voltage having a different magnitude, so the conversion efficiency of the converter is very important. However, it is not efficient to convert DC voltage into DC voltage having a different amplitude. Accordingly, the efficiency is considerably improved in this case by converting DC voltage into AC voltage, converting the AC voltage into AC voltage having a different magnitude using a transformer, and then converting the AC voltage into DC voltage even though the conversion process may be more complicated. Therefore, the present disclosure may propose the multi-converter 30 including the multi-transformer 80 to improve conversion efficiency. The multi-transformer 80 is a transformer from which a user can obtain voltages having various magnitudes by attaching a desired number of coils to a secondary side, but only charging voltage for charging the main battery 10 and the auxiliary battery 20 is required in the present disclosure, so the present disclosure may propose a type having two coils at the secondary side, which can be seen in FIG. 1.

If coils are provided to the secondary side of the multi-transformer 80, it may be possible to determine the output voltage at the output terminal of each transformer from a ratio of a coil winding factor. The output voltage of a transformer may be the voltage for charging the main battery 10 and the auxiliary battery 20 in the present disclosure, so the voltage at the main battery 10 may be be higher than the voltage at the auxiliary battery 20. Accordingly, the coil winding factor of the multi-transformer 80 may satisfy the following expression.

N>M>K

wherein N is the coil winding factor at the primary side, M is the coil winding factor at the main battery 10, and K is the coil winding factor at the auxiliary battery 20.

If the multi-transformer 80 can satisfy the above expression, there may be a need for a converter that can convert DC voltage into AC voltage, as described above. Accordingly, the multi-converter 30 may be provided with a converter for converting voltage for all of the external power supply, the main battery 10, and the auxiliary battery 20. Further, this converter, although it will be described below, functions as a switch for making various charging plans for the main battery 10 and the auxiliary battery 20. Accordingly, by using the multi-converter having the configuration described above, it may be possible to flexibly perform charging control on the external power supply, the main battery 10, and the auxiliary battery 20 in accordance with various charged states.

As shown in FIG. 1, the charging control system for an electric vehicle according to the present disclosure may include a power factor corrector 50 that is connected between the external power supply and the multi-converter 30 and thus may improve the power factor of external power. In general, the external power used in electric vehicles may be AC power of 220V or 110V. Accordingly, the power factor corrector 50 improving a power factor may be provided to minimize reactive power due to the characteristics of AC power.

The power factor corrector 50 is generally equipped with a

DC/DC converter at the rear end to convert DC voltage converted by the power factor corrector 50 into DC voltage. According to the present disclosure, the power factor corrector 50 and the multi-converter 30 may be connected, so there may be no need for a specific DC/DC converter, and the converter for the external power supply in the multi-converter 30 can be used. Therefore, according to the present disclosure, the DC/DC converter in the power factor corrector 50 can be removed, so it may be possible to achieve the effect of reducing the size and manufacturing costs of the device and further increasing the efficiency.

Further, the charging control system for an electric vehicle, as shown in FIG. 1, may include a first converter 60 connected between the output terminal for the main battery 10 of the multi-converter 30 and the main battery 10 to achieve bidirectional conversion and a second converter 70 connected between the output terminal for the auxiliary battery 20 of the multi-converter 30 and the auxiliary battery 20 to achieve bidirectional conversion. The first converter 60 and the second converter 70 are provided to cope with various types of charging plans according to the states of the main battery 10 and the auxiliary battery 20, and both can operate in a bidirectional mode, that is, in both buck and boost modes. That is, converters that can operate in both buck and boost modes are used to control, in various ways, the current flow between the main battery 10 and the multi-converter 30, and between the auxiliary battery 20 and the multi-converter 30.

If all of the multi-converter 30, the first converter 60, and the second converter 70 are provided, the controller 40 for controlling turning on/off the converters and the buck/boost modes may be required. This is because the charging plan of an electric vehicle depends on how the controller 40 turns on/off the converters or controls them in buck/boost modes. Accordingly, the controller 40 of the present disclosure, as shown in FIG. 1, may control not only turning on/off the first converter 60 and the second converter 70 and the buck/boost modes, but also turning on/off the converters for the external power, the main battery 10, and the auxiliary battery 20 in the multi-converter 30.

The way that the controller 40 controls the converters, as described above, depends on the charged states of the main battery 10 and the auxiliary battery 20. It may be difficult to determine the charged states of the main battery 10 and the auxiliary battery 20, so the present disclosure provides a method of sensing the SOC (State Of Charge) of the main battery 10 and the auxiliary battery 20 as a way of determining the charged states. The SOC is a reference for determining the charged state of a battery, and a high SOC means that a battery is in a state close to a fully charged state. In general, an SOC of 20˜80% means a normal state, an SOC of 20% or less means a discharged state, and an SOC of 80% or more means a fully charged state. However, these references may be changed in accordance with the state, or design, of a battery.

The charging control method for an electric vehicle may be changed not only in accordance with the charged state of a battery, as described above, but also in accordance with whether power can be supplied to the vehicle by the external power supply. Accordingly, the charging method by the controller 40 considering each situation is described hereafter.

A first case is when power is supplied to an electric vehicle by the external power supply, in which both of the main battery 10 and the auxiliary battery 20 need to be charged. In this case, the controller 40 according to an embodiment of the present disclosure, may turn on the converters for the external power, the main battery 10, and the auxiliary battery 20 in the multi-converter 30 and may turn on the first converter 60 and second converter 70 in a boost mode. This is because the most preferable control is to charge the main battery 10 and the auxiliary battery 20 using the power from the external power supply in this case.

That is, the converter for the external power is turned on to input the power from the external power supply to the multi-converter 30, and the main battery 10 and the auxiliary battery 20 both need to be charged, so the converters for the main battery 10 and the auxiliary battery 20 are both turned on. Further, because it is required to charge both of the main battery 10 and the auxiliary battery 20, the first converter 60 connected to the main battery 10 and the second converter 70 connected to the auxiliary battery 20 are both turned on and operated in the boost mode so that the power converted by the multi-converter can be supplied to the main battery 10 and the auxiliary battery 20.

A second case is when power is supplied to an electric vehicle by the external power supply, in which only the main battery 10 needs to be charged. In this case, the controller 40 according to an embodiment of the present disclosure may turn on the converters for the external power, the main battery 10, and the auxiliary battery 20 in the multi-converter 30, may turn on the first converter 60 in the boost mode, and may turn off the second converter 70. The reason for this is that when the auxiliary battery 20 does not need to be charged, there is no need to supply power to the auxiliary battery 20.

That is, since power is supplied by an external power supply even in this case, the converter for the external power in the multi-converter 30 is turned on and the converters for the main battery 10 and the auxiliary battery 20 are also turned on to use the power. However, since only the main battery 10 needs to be charged by the external power supply in this case, the first converter 60 connected to the main battery 10 may be turned on in the boost mode, but the second converter 70 connected to the auxiliary battery 20 may be turned off to prevent the unnecessary supply of power. Accordingly, power supply to the auxiliary battery 20 may be stopped and more power can be supplied to the main battery 10, so charging efficiency for the main battery 10 can be increased.

A third case is when power is not supplied from the external power supply, in which both of the main battery 10 and the auxiliary battery 20 are in a normal charged state. Electric vehicles may occupy this state most of the time, unless there is a specific circumstance requiring another state. In this case, the controller 40 according to an embodiment of the present disclosure may turn off the converter for the external power in the multi-converter 30, may turn on the converters for the main battery 10 and the auxiliary battery 20, and may turn on the first converter 60 in the buck mode and the second converter 70 in the boost mode. The converters for the main battery 10 and the auxiliary battery 20 of the multi-converter 30 may always be turned on, unless there is some specific circumstance requiring otherwise. This is because the auxiliary battery 20 in a common automotive battery system allows for starting of a vehicle, so the main battery 10 keeps supplying power to the auxiliary battery 20 to prevent the auxiliary battery 20 from being fully discharged, when the main battery 10 is turned on.

That is, when the main battery 10 is not fully discharged in this case, which is such a specific situation, the converters for the main battery 10 and the auxiliary battery 20 of the multi-converter 30 may be turned on so that the main battery 10 keeps supplying power to the auxiliary battery 20 to prevent the auxiliary battery 20 from being fully discharged. However, power may not be supplied from the external power supply in this case, so it may not required to turn on the converter for the external power. Accordingly, the consumption of power by the converter for the external power in the multi-converter 30 may be prevented by turning off the converter for the external power supply, so the efficiency of the charging system for an electric vehicle can be increased. Further, in this case, a charging path is formed from the main battery 10 to the auxiliary battery 20, so the first converter 60, which is connected to the main battery 10, may be turned on in the buck mode, and the second converter, which is connected to the auxiliary battery 20, may be turned on in the boost mode.

Finally, a fourth case is when power is not supplied from the external power supply and the main battery 10 needs to be charged. This case may be considered to be an emergency situation if the electric vehicle is currently being driven, because the electric vehicle cannot be driven if the main battery 10 is fully discharged. Thus, the present disclosure proposes a method that can charge the main battery 10 temporarily using the auxiliary battery 20 in this emergency situation.

In this case, since power is not supplied from the external power supply, the converter for the external power of the multi-converter 30 may be turned off and the converters for the main battery 10 and the auxiliary battery 20 may both be turned on to improve the efficiency of the multi-converter 30. Further, the first converter 60 connected to the main battery 10 may be turned on in the boost mode and the second converter 70 connected to the auxiliary battery 20 may be turned on in the buck mode. Accordingly, the power of the auxiliary battery 20 may be supplied to the main battery 10, so the main battery 10 can be temporarily charged by the auxiliary battery 20 even though it is fully discharged.

In general, the power for the auxiliary battery 20 is different from the power for the main battery 10, so appropriate power conversion may be required to charge the main battery 10 using the auxiliary battery 20 and can be achieved by the multi-transformer 80 in the multi-converter 30, as described above, and the detailed control method may be to adjust the coil winding factor at the main battery 10 and the coil winding factor at the auxiliary battery 20 of the multi-transformer.

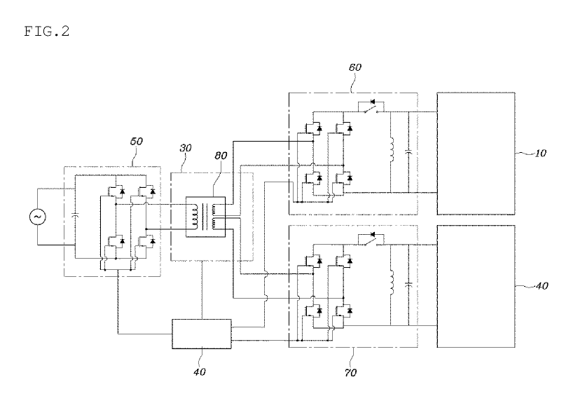

FIG. 2 shows a detailed circuit for achieving the present disclosure. Unlike FIG. 1, FIG. 2 shows in detail the circuit structure in the multi-converter 30, the power factor corrector 50, the first converter 60 and the second converter 70. The circuit shown in FIG. 2 may be a circuit having a switch device of an IGBT (Insulated Gate Bipolar Transistor) as an example for achieving the present disclosure, but the present disclosure is not limited thereto. Any type of circuit is available as long as it is possible to control turning on/off each device in response to signals from the controller 40, so various devices such as MOS, BJT, and a diode, other than the IGBT switch device can be used.

Therefore, even though the main battery 10 is fully discharged, the main battery 10 can be temporarily charged by the auxiliary battery 20 through the control described above. As described, it is possible to ensure adequate power to drive the electric vehicle to a charge station where the main battery can be charged, and it is thus possible to improve an emergency driving function of an electric vehicle.

Although the present disclosure was described with reference to specific embodiments shown in the drawings, it is apparent to those skilled in the art that the present disclosure may be changed and modified in various ways without departing from the scope of the present disclosure, which is described in the following claims.

What is claimed is:

1. A charging control system for an electric vehicle, comprising:
a main battery supplying power for driving the electric vehicle;
an auxiliary battery supplying power to electric loads of the electric vehicle;
a multi-converter connecting an external power supply, the main battery and the auxiliary battery and outputting voltage for charging the main battery and the auxiliary battery according to turning on/off a switch therein; and
a controller controlling turning on/off the switch in the multi-converter in accordance with charged states of the main battery and the auxiliary battery so that the main battery or the auxiliary battery is charged.

2. The system of claim 1, further comprising a power factor corrector connected between the external power supply and the multi-converter.

3. The system of claim 1, further comprising:
a first converter connected between an output terminal for the main battery of the multi-converter and the main battery to achieve bidirectional conversion; and
a second converter connected between an output terminal for the auxiliary battery of the multi-converter and the auxiliary battery to achieve bidirectional conversion.

4. The system of claim 3, wherein the controller controls turning on/off converters for external power, the main battery, and the auxiliary battery in the multi-converter and further controls turning on/off and controls buck/boost modes of the first converter and the second converter in accordance with charged states of the main battery and the auxiliary battery.

5. The system of claim 4, wherein when both of the main battery and the auxiliary battery need to be charged, the controller turns on the converters for the external power, the main battery, and the auxiliary battery in the multi-converter and turns on the first converter and the second converter in the boost mode.

6. The system of claim 4, wherein when the main battery needs to be charged, the controller turns on the converters for the external power, the main battery, and the auxiliary battery in the multi-converter, turns on the first converter in the boost mode, and turns off the second converter.

7. The system of claim 4, wherein when power is not supplied from the external power supply, the controller turns off the converter for the external power in the multi-converter.

8. The system of claim 7, wherein when the main battery is not fully discharged, the controller turns on the first converter in the buck mode and the second converter in the boot mode.

9. The system of claim 7, wherein when the main battery needs to be charged, the controller turns on the first converter in the boost mode and the second converter in the buck mode.

10. The system of claim 1, wherein the controller determines the charged states of the main battery and the auxiliary battery on the basis of an SOC of the main battery and the auxiliary battery.

11. The system of claim 1, wherein the multi-converter includes a multi-transformer for converting voltage of the external power supply into voltage for charging the main battery and the auxiliary battery.

12. The system of claim 1, wherein a coil winding factor of the multi-transformer satisfies the expression N>M>K, wherein N is a coil winding factor at a primary side, M is a coil winding factor at the main battery, and K is a coil winding factor at the auxiliary battery.
